(19) United States
(12) Patent Application Publication
(10) Pub. No.: US 2012/0188391 A1
(43) Pub. Date: Jul. 26, 2012

(54) ARRAY CAMERA HAVING LENSES WITH INDEPENDENT FIELDS OF VIEW

(76) Inventor: Scott Smith, San Jose, CA (US)

(21) Appl. No.: 13/036,334

(22) Filed: Feb. 28, 2011

Related U.S. Application Data
(60) Provisional application No. 61/436,052, filed on Jan. 25, 2011.

(51) Int. Cl. H04N 5/262; H04N 3/12

(52) U.S. Cl. 348/222.1; 348/332; 348/E05.051; 348/E03.021

(57) ABSTRACT

A camera module may be formed from an array of lenses and corresponding image sensors. The array of lenses may be configured so that the lenses and image sensors each capture an image of a different portion of an object. The lenses in the array may include rotationally asymmetric lenses such as wedge-shaped lenses. The image sensors may be formed in a two-dimensional array on a common image sensor integrated circuit die. The camera module may be mounted in a portable electronic device. Processing circuitry in the portable electronic device may be coupled to the image sensor array and may process the individual images. During image processing, the individual images of the object may be stitched together to form a composite image of the object.

This application claims the benefit of provisional patent application No. 61/436,052, filed Jan. 25, 2011, which is hereby incorporated by reference herein in its entirety.

### BACKGROUND

This relates generally to imaging devices, and more particularly, to imaging devices with multiple lenses and image sensors.

Image sensors are commonly used in electronic devices such as cellular telephones, cameras, and computers to capture images. In a typical arrangement, an electronic device is provided with a single image sensor and a single corresponding lens. Particularly in compact devices such as portable electronic devices in which the volume available for imaging components is limited, it can be difficult to improve image quality with this type of arrangement. Larger image sensors and lenses can be used to improve image quality, but can be impractical in compact devices.

It would therefore be desirable to be able to improve image quality for an electronic device such as a portable electronic device without using imaging components of excessive size.

### BRIEF DESCRIPTION OF THE DRAWINGS

FIG. 1 is a diagram of an illustrative electronic device in accordance with an embodiment of the present invention.

FIG. 2 is a diagram of a conventional camera module arrangement in which the camera module includes an array of rotationally symmetrical lenses and corresponding image sensors that result in substantially overlapping fields of view.

FIG. 3 is a diagram showing how images from the image sensors of the conventional camera module of FIG. 2 overlap substantially with each other.

FIG. 4 is a cross-sectional side view of a rotationally symmetrical lens in accordance with an embodiment of the present invention.

FIG. 5 is a cross-sectional side view of a rotationally asymmetric lens in accordance with an embodiment of the present invention.

FIG. 6 is a diagram showing an array of rotationally asymmetric lenses and corresponding image sensors that have fields of view that are substantially not overlapping in accordance with an embodiment of the present invention.

FIG. 7 is a diagram showing how images from the images sensors of the camera module of FIG. 2 may overlap only slightly at the edges of the images in accordance with an embodiment of the present invention.

FIG. 8 is a diagram showing how images from a camera module with a two-dimensional array of images sensors and a corresponding array of lenses that includes rotationally asymmetric lenses may be configured so that the images overlap only slightly at the edges of the images in accordance with an embodiment of the present invention.

FIG. 9 is a flow chart of illustrative steps involved in capturing images from a camera module having an array of rotationally asymmetric lenses in accordance with an embodiment of the present invention.

### DETAILED DESCRIPTION

Digital camera modules are widely used in electronic devices such as digital cameras, computers, cellular telephones, or other electronic devices. These electronic devices may include image sensors that gather incoming light to capture an image. The image sensors may include arrays of image pixels. The pixels in the image sensors may include photosensitive elements such as photodiodes that convert the incoming light into digital data. Image sensors may have any number of pixels (e.g., hundreds or thousands or more). A typical image sensor may, for example, have hundreds of thousands or millions of pixels (e.g., megapixels).

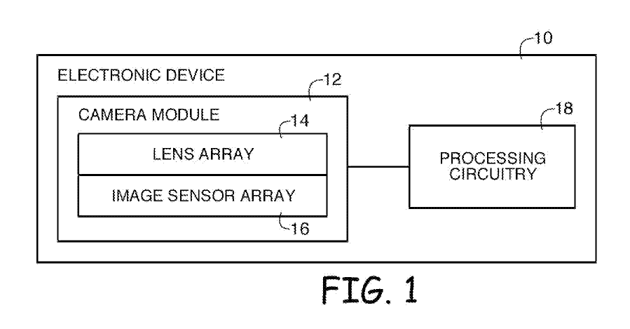

FIG. 1 is a diagram of an illustrative electronic device that uses an image sensor to capture images. Electronic device 10 of FIG. 1 may be a portable electronic device such as a camera, a cellular telephone, a video camera, or other imaging device that captures digital image data. Camera module 12 may be used to convert incoming light into digital image data. Camera module 12 may include an array of lenses 14 and a corresponding array of image sensors 16. Lenses 14 and image sensors 16 may be mounted in a common package and may provide image data to processing circuitry 18. Processing circuitry 18 may include one or more integrated circuits (e.g., image processing circuits, microprocessors, storage devices such as random-access memory and non-volatile memory, etc.) and may be implemented using components that are separate from camera module 12 and/or that form part of camera module 12 (e.g., circuits that form part of an integrated circuit that includes image sensors 16 or an integrated circuit within module 12 that is associated with image sensors 16). Image data that has been captured by camera module 12 may be processed and stored using processing circuitry 18. Processed image data may, if desired, be provided to external equipment (e.g., a computer or other device) using wired and/or wireless communications paths coupled to processing circuitry 18.

There may be any suitable number of lenses 14 in lens array 14 and any suitable number of image sensors in image sensor array 16. Lens array 14 may, as an example, include N*M individual lenses arranged in an N×M two-dimensional array. The values of N and M may be equal to or greater than two, may be equal to or greater than three, may exceed 10, or may have any other suitable values. Image sensor array 16 may contain a corresponding N×M two-dimensional array of individual image sensors. The image sensors may be formed on one or more separate semiconductor substrates. With one suitable arrangement, which is sometimes described herein as an example, the image sensors are formed on a common semiconductor substrate (e.g., a common silicon image sensor integrated circuit die). Each image sensor may be identical. For example, each image sensor be a Video Graphics Array (VGA) sensor with a resolution of 480×640 sensor pixels (as an example). Other types of image sensor may also be used for the image sensors if desired. For example, images sensors with greater than VGA resolution or less than VGA resolution may be used, image sensor arrays in which the image sensors are not all identical may be used, etc.

The use of a camera module with an array of lenses and an array of corresponding image sensors (i.e., an array camera) may allow images to be captured with higher quality (e.g., lower noise, greater resolution, and improved color accuracy) than would be possible using a single image sensor of the same size. To increase image quality efficiently, however, it is preferable that the fields of view of each lens-sensor pair be substantially non-overlapping and therefore substantially independent.

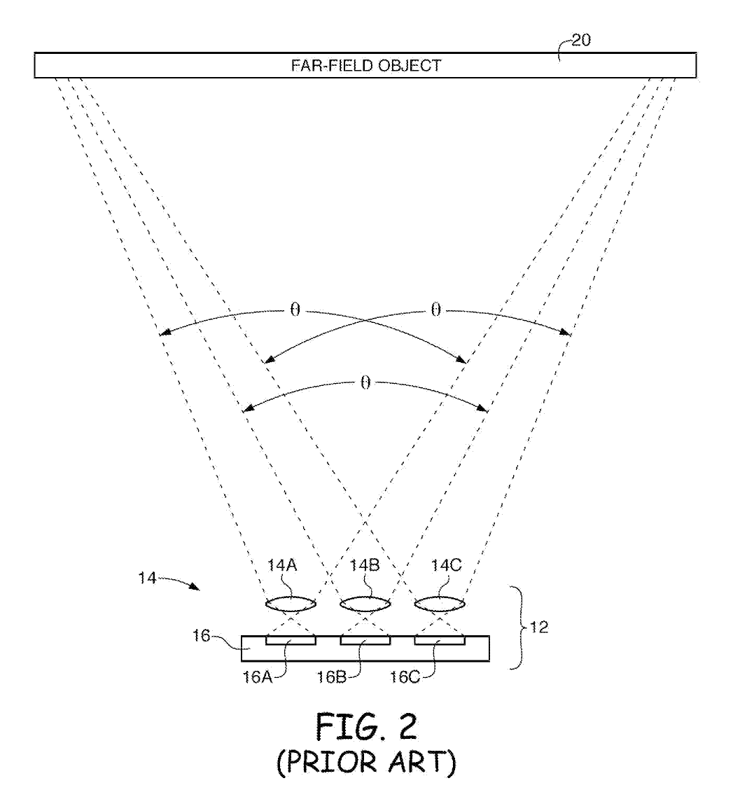

A diagram of a conventional array camera with an array of identical lenses and corresponding image sensors having substantially overlapping fields of view is shown in FIG. 2. In the example of FIG. 2, array camera (camera module 12) has a lens array 14 that is made up of three lenses: lenses 14A, 14B, and 14C. Lenses 14A, 14B, and 14C each focus image light from an object such as far-field object 20 onto a respective image sensor in image sensor array 16. In particular, lens 14A may be used to focus image light onto image sensor 16A, lens 14B may be used to focus image light onto image sensor 16B, and lens 14C may be used to focus image light onto image sensor 16C. With a camera array of the type shown in FIG. 2, the images that are captured by each image sensor tend to be nearly identical, particularly when the object that is being imaged is far away, such as far-field object 20.

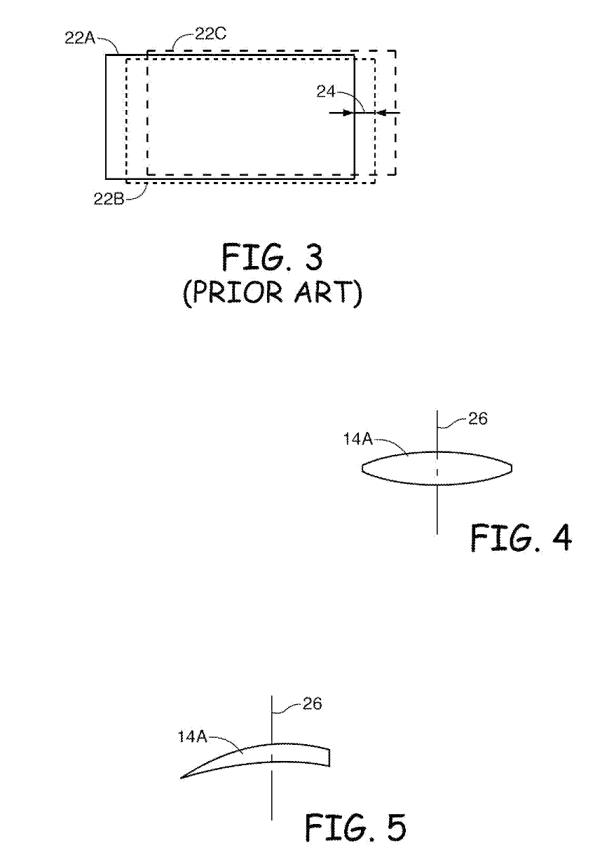

As shown in FIG. 3, for example, the array camera of FIG. 2 may capture images such as image 22A, image 22B, and image 22C that overlap substantially. Image 22A may be captured using lens 14A and image sensor 16A. Image 22B may be captured using lens 14B and image sensor 16B. Image 22C may be captured using lens 14C and image sensor 16C. In practice, due to alignment variations and other manufacturing variations, the amount of lateral mismatch 24 between images 22A, 22B, and 22C may be negligible (e.g., less than a few pixels). Following image capture of images 22A, 22B, and 22C with the array camera, these individual images may be merged to produce a final image. While image quality of the final merged image will generally be improved over the image quality of any one of the individual images, more substantial image quality improvements may be made without increasing the number of image sensors by ensuring that the fields of view of each individual lens and image sensor pair are substantially non-overlapping.

An array camera with non-overlapping fields of view may be implemented using rotationally asymmetric lenses. A cross-sectional side view of a lens of the type used in the array camera of FIG. 2 is shown in FIG. 4. As shown in FIG. 4, lens 14A is rotationally symmetric with respect to rotational axis 26 (i.e., an axis that passes through the center of the lens, normal to the surface of the lens). The FIG. 4 example involves the use of a single-element lens. Multiple-element symmetric lenses may also be used in forming an array of identical lenses in array cameras of the type shown in FIG. 2.

A cross-sectional side view of an asymmetric lens of the type that may be used in an array camera with non-overlapping fields of view is shown in FIG. 5. As shown in FIG. 5, illustrative lens 14A has a wedge shape that is rotationally asymmetric (i.e., lens 14A of FIG. 5 is not rotationally symmetric about rotational axis 26). The example of FIG. 5 involves the use of a single-element lens. This is merely illustrative. Asymmetric lenses such as lens 14A of FIG. 5 may be formed using any suitable number of lens elements (e.g., one rotationally asymmetric element, two or more elements, etc.). Aspheric elements, wedge-shaped elements, other elements, and combinations of these elements may be included, provided that the resulting lens is rotationally asymmetric.

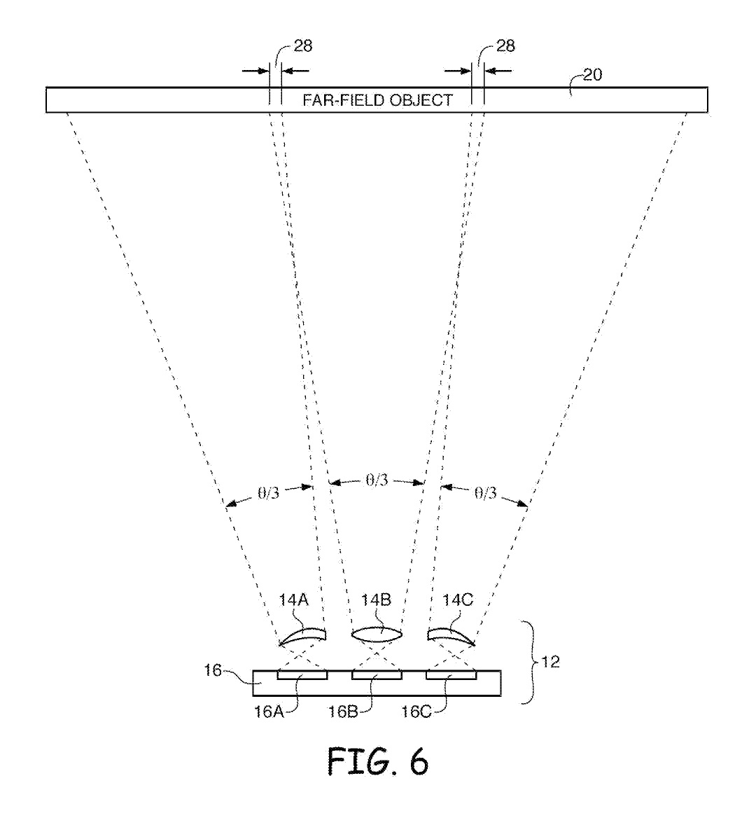

A diagram of an array camera (camera module 12) that includes rotationally asymmetric lenses such as lens 14A of FIG. 5 is shown in FIG. 6. In the example of FIG. 6, camera module 12 has there lenses: lens 14A, lens 14B, and lens 14C. Lenses 14A and 14C are rotationally asymmetric lenses. Central lens 14B is a rotationally symmetric lens. In other array configurations, all lenses will be rotationally asymmetric. For example, in a one-dimensional array camera with four lenses, the two left-hand lenses will be rotationally asymmetric lenses and the two right-hand lenses will be rotationally asymmetric lenses,

As shown in FIG. 6, rotationally asymmetric lens 14A focuses image light from the left-hand portion of far-field object 20 onto image sensor 16A of image sensor array 16. Rotationally symmetric lens 14B focuses image light from the central portion of far-field object 20 onto image sensor 16B. Rotationally asymmetric lens 14C focuses image light from the right-hand portion of far-field object 20 onto image sensor 16C. In the rotationally-symmetric-lens array camera of FIG. 2, lenses 14A, 14B, and 14C each have a field of view of θ. In contrast, the field of view of each of the lenses in the rotationally-asymmetric-lens array camera of FIG. 6 is typically narrower (e.g., θ/3 in the illustrative example of FIG. 6), so that the images that are acquired by each image sensor cover different portions of the far field object and do not overlap as much as the images acquired using the array camera of FIG. 2. For maximum image resolution, the fields of view of FIG. 6 preferably overlap only minimally (as shown by relatively small overlap regions 28 in FIG. 6), provided that there is sufficient overlap to reconstruct a full undistorted composite image of object 20 by merging the individual images.

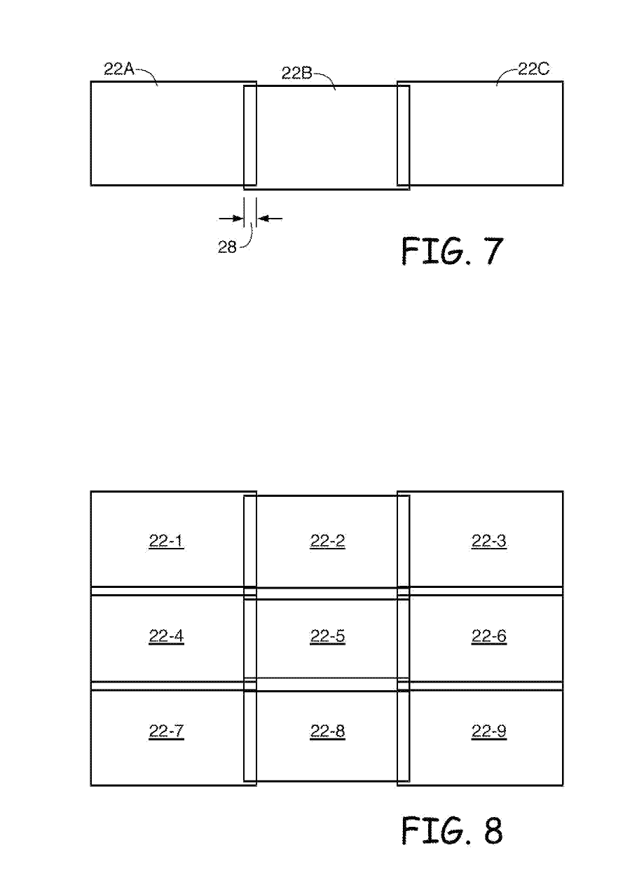

As shown in FIG. 7, array camera 12 of FIG. 6 may capture three substantially non-overlapping images 22A, 22B, and 22C. Image 22A may be captured by asymmetric lens 14A and image sensor 16A, image 22B may be captured by symmetric lens 14B and image sensor 16B. Image 22C may be captured by asymmetric lens 14C and image sensor 16C. There is preferably only a relatively small amount of overlap 28 between adjacent images. For example, image 22A may overlap with image 22B by 20% or less, 10% or less, 5% or less, or 1% or less. Images 22B and 22C may likewise overlap only a small amount. During image reconstruction operations, images 22A, 22B, and 22C can be merged to provide a composite image of object 20 that is of significantly greater quality than would be possible if using only a single sensor. For example, if the resolution of one image is R, the resolution of the reconstructed image formed by merging images 22A, 22B, and 22C will be about 3*R.

Array cameras such as camera module 12 of FIG. 6 with rotationally-asymmetric lenses may be formed using any suitable number of lenses and corresponding sensor arrays. For example, two-dimensional array cameras may be formed using N*M arrays of rotationally asymmetric lenses and images sensors where N and M are each at least equal to two. FIG. 8 shows how a 3×3 array camera (N and M equal to 3) may be used to capture nine separate substantially non-overlapping images 22-1, 22-2, 22-3, and 22-4, 22-5, 22-6, 22-7, 22-8, and 22-9. These images may be merged to create an image with approximately nine times greater resolution than each individual image. Larger arrays and arrays with different N and M values may be used if desired (e.g., arrays with four lenses and four image sensors, arrays with more than four lenses and more than four image sensors, arrays with more than nine lenses and more than nine image sensors, etc.).

Because there are multiple images sensors in image sensor array 14, each image sensor may be of relatively modest size and each corresponding lens in the lens array may be correspondingly of modest size. This allows the array camera to be installed in thin devices such as thin cameras, thin cellular telephones, and other devices where a thin form factor is desired.

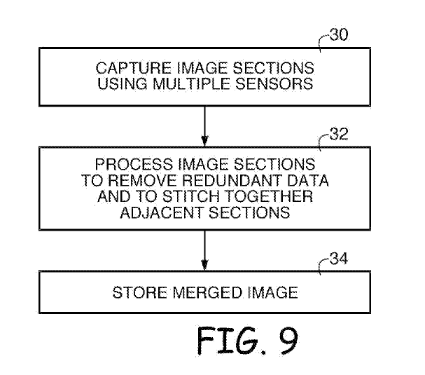

FIG. 9 is a flow chart of illustrative steps involved in capturing images using an asymmetric lens array camera of the type shown in FIG. 6 (e.g., a two-dimensional array camera).

At step 30, camera module 12 may use each of its individual image sensors (i.e., each of the image sensors in image sensor array chip 16) to capture individual images each covering only a respective part of the overall desired field of view for camera module 12. Because the images do not substantially overlap, the images act as tiles that each cover a desired subsection of the final image. The captured images may be stored in memory within processing circuitry 18 (FIG. 1).

At step 32, the individual images that have been captured may be processed using image processing circuitry 18. Image processing circuitry 18 may be implemented using circuits that are mounted on a printed circuit board or other substrate that is separate from camera module 12 and/or may be incorporated into circuitry within camera module 12 (e.g., circuitry on image sensor array integrated circuit 12). During the processing operations of step 32, overlapping edge portions of the images (e.g., portions such as portion 28 of FIG. 7) may be discarded and the resulting cropped images may be stitched together to form a final combined image of object 20. If desired, lens distortion correction algorithms may be used to correct each of the individual images for lens distortion imposed by the lenses in array 14 to ensure that the resulting composite image is accurate.

Following image processing operations to combine each of the individual images into the composite image of the object, the merged image may be stored in non-volatile storage within processing circuitry 18 (step 34).

Various embodiments have been described illustrating array cameras that include asymmetric lenses. The rotationally asymmetric lenses and associated image sensors in an image sensor array may be used to capture respective subsections of an image. Each image subsection may be stored in memory. Processing circuitry may be used to process the subsection images to form a composite image. The composite image may be stored in memory following operations to stitch together the individual images.

The foregoing is merely illustrative of the principles of this invention which can be practiced in other embodiments.

What is claimed is:

1. A camera module, comprising:
an array of lenses including rotationally asymmetric lenses; and
an array of corresponding images sensors each of which receives image light from a corresponding one of the lenses.

2. The camera module defined in claim 1 wherein the array of lenses comprises a two-dimensional array of at least four lenses.

3. The camera module defined in claim 2 wherein the image sensors are formed as part of a common image sensor integrated circuit die.

4. The camera module defined in claim 3 wherein the rotationally asymmetric lenses include at least one wedge-shaped lens.

5. The camera module defined in claim 4 wherein the lenses include at least one rotationally symmetric lens.

6. A method of capturing images using a camera module in a portable electronic device that includes an array of lenses with rotationally asymmetric lenses and corresponding image sensors on an image sensor integrated circuit die, comprising:
with the images sensors and array of lenses in the camera module, capturing substantially non-overlapping images of respective portions an object; and
with processing circuitry in the portable electronic device, stitching together each of the substantially non-overlapping images to produce a composite image of the object.

7. The method defined in claim 6 wherein the image sensor integrated circuit die includes at least four image sensors and wherein capturing the non-overlapping images comprises capturing the non-overlapping images using the four image sensors.

8. The method defined in claim 7 wherein capturing the non-overlapping images using the four image sensors comprises capturing images that overlap less than 10%.

9. The method defined in claim 6 further comprising:
storing the composite image in memory within the processing circuitry following the stitching of the non-overlapping images.

10. The method defined in claim 6 wherein the rotationally asymmetric lenses include at least some wedge-shaped lenses and wherein capturing the non-overlapping images comprises capturing the non-overlapping images using the wedge-shaped lenses.

11. A portable electronic device, comprising:
a camera module that includes an array of lenses including rotationally asymmetric lenses and an array of corresponding images sensors each of which receives image light from a corresponding one of the lenses and each of which captures an image corresponding to a different respective subsection of an object; and
processing circuitry coupled to the camera module for processing the images.

12. The portable electronic device defined in claim 11 wherein the image sensors are each formed as part of a common image sensor integrated circuit die.

13. The portable electronic device defined in claim 12 wherein the processing circuitry is configured to stitch together each of the images to form a composite image of the object.

14. The portable electronic device defined in claim 13 wherein the processing circuitry includes storage and wherein the processing circuitry is configured to store the composite image of the object in the storage.

15. The portable electronic device defined in claim 14 wherein the rotationally asymmetric lenses include at least some wedge-shaped lenses.

16. The portable electronic device defined in claim 15 wherein the array of lenses includes a rotationally symmetric lens.

17. The portable electronic device defined in claim 12 wherein the image sensor integrated circuit die includes at least four of image sensors and wherein the array of lenses includes at least four corresponding rotationally asymmetric lenses.

18. The portable electronic device defined in claim 17 wherein the array of lenses and the image sensor integrated circuit die are configured so that the images overlap each other by less than 10%.

19. The portable electronic device defined in claim 18 wherein the image sensor integrated circuit die includes at least nine image sensors each of which has a resolution of at least 480×640 sensor pixels and wherein the array includes a rotationally symmetric lens.

20. The portable electronic device defined in claim 11 wherein the array of image sensors includes at least four image sensors on a common integrated circuit die and wherein the rotationally asymmetric lenses are each mounted above a respective one of the four image sensors within the camera module.
